(19) United States
(12) Patent Application Publication
(10) Pub. No.: US 2013/0024480 A1
(43) Pub. Date: Jan. 24, 2013

(54) METHOD AND SYSTEM FOR ANALYSIS OF DATABASE RECORDS

(71) Applicants: Justin A. Okun, Lake Forest, CA (US); Michael Alan Gale, Aliso Viejo, CA (US)

(72) Inventors: Justin A. Okun, Lake Forest, CA (US); Michael Alan Gale, Aliso Viejo, CA (US)

(21) Appl. No.: 13/184,851

(22) Filed: Jul. 18, 2011

(51) Int. Cl. G06F 17/30

(52) U.S. Cl. 707/802; 707/E17.005

(57) ABSTRACT

Method, system, and programs for analyzing data records, to easily identify problems with saved data, facilitate data retrieval and file report optimization. In an embodiment, the user is presented with a visual representation of the data records to alert the user of any problems, omissions, or errors in the data.

### FIELD OF THE INVENTION

The present teaching relates to methods, systems and programming for analyzing database records. Particularly, the present teaching is directed to methods, systems, and programming for providing a visual indication that report records may be omitted, missing or corrupt.

### BACKGROUND

Computer system records often contain host operating statistics for a host system that may be used in generating reports on system resource consumption, usage, processes, etc. One such system is the Work Load Manager (WLM) from Unisys Corporation. That is, the WLM system captures and collects information, records, and operational statistical data such as processor errors, processor statistics, memory usage, CPU operation times, and CPU cycles from numerous servers and systems. The captured data may be recorded into a file or database, on a system or on a standalone management server or system. The data is then available to users and other processes for extraction and further processing. One such use involves the metering or monitoring of a third party's usage of system resources. In such a system, a third party or workgroup may lease or borrow time or resources on a system or server. Such usage may be free of charge as in the case of work groups within the same organization sharing resources, or may be a for fee service as in the case of a third party purchasing CPU time on a larger system. In either case, it is important to know exactly how resources are being utilized, whether a system is approaching maximum capacity, and how much to charge a purchaser for time or resources used. A problem occurs however, when there are gaps or missing records in the data. Missing records may be the result of and indicative of corrupt data, mis-configured data, data that exists but was not captured or downloaded, or any combination of problem. For example, if a user is requesting a CPU usage report, on which a customer or third-party will be billed, there is no way to know from the report itself, if gaps in the records exists, such that the report may be under reporting a third-party's usage. In order to ensure proper data collection, proper analysis, to avoid future errors, and to troubleshoot problems, it is important to easily identify if records are missing and why a gap or error in the data may exists.

Additionally, reports generated from data containing gaps or missing records, often raise red flags about the quality of the data, the integrity of the system and the report itself. It is therefore desirable to be able to generate reports that omit, or ignore the gaps in all reports or future reports.

Accordingly, a need exists for a system that allows a user to visually identify gaps in the data in a data repository, that displays inconsistencies in the data stored in the repository, and/or visually identifies invalid data if any in a statistics repository and to provide a method for retrieving the missing data to the extent it exists. Further, a need exists for a method for a user to ignore any gaps in the data so that the missing, corrupt or omitted periods will not be reported as gaps or invalid data in reports or future reports.

### SUMMARY

In an embodiment, analysis of data records is visually displayed to a user. In another embodiment, a method, for analyzing data files on a machine having at least one processor, storage, and a communication platform comprises the steps of retrieving data records from a database, analyzing the retrieved records utilizing the at least one processor, creating a map of the retrieved records utilizing the at least one processor, and displaying the map of the retrieved records to a user.

In another embodiment, a map visually indicates the status of the retrieved records. In another embodiment, the status of the retrieved records is at least one of the following: all records present, unexpected break in the records, missing records, records not requested, ignored records, no activity, and auditing information unavailable.

In another embodiment, the user can select to ignore the missing records. In another embodiment, the method further comprises requesting missing data records stored in the database, retrieving the missing data records from the database, combining the retrieved records and the missing data records, recreating the map based on the combined records; and redisplaying the map.

In another embodiment, the method further comprises the steps of requesting previously un-requested records from a server via the communications platform, receiving the previously un-requested records from the server via the communications platform, storing the previously un-requested records in the database, combining the retrieved records and the previously un-requested records, recreating the map based on the combining, and redisplaying the map.

In another embodiment, a machine readable non-transitory and tangible medium having information recorded thereon is disclosed. The information for analyzing data files on a machine having at least one processor, storage, and a communication platform, to causes the machine to perform the following: retrieving data records from a database, analyzing the retrieved records utilizing the at least one processor, creating a map of the retrieved records utilizing the at least one processor and displaying the map of the retrieved records to a user.

In still another embodiment, the medium contains information such that the map visually indicates the status of the retrieved records. In another embodiment, the medium contains information such the status is at least one of the following: all records present, unexpected break in the records, missing records, records not requested, ignored records, no activity and auditing information unavailable.

In another embodiment the medium contains information such that the user can select to ignore the missing records. In another embodiment, the medium further comprising the steps of requesting missing data records stored in the database, retrieving the missing data records from the database, combining the retrieved records and the missing data records, recreating the map based on the combining and redisplaying the map.

In another embodiment, the medium further comprises the steps of requesting previously un-requested records from a server via the communications platform, receiving the previously un-requested records from the server via the communications platform, and storing the previously un-requested records in the database

In an embodiment, a system for visually displaying the status of data records is disclosed. The system comprising a data management server for requesting data records via a communications link from a plurality of servers, a memory for storing the data records from the plurality of servers and wherein the data management server processes the data records using a processor and generates a visual representation of the status of the requested data records for display on a user terminal.

In an embodiment the system data management server can request missing data records via the communications from the plurality of servers. In another embodiment, any or all parts of the data management server, the memory, and the plurality of servers may be implemented in a cloud computing environment.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a schematic representation of a system in accordance with an exemplary embodiment;

FIG. 2 illustrates a representation of a report display in accordance with an exemplary embodiment;

FIG. 3 illustrates a representation of a statistics display in accordance with an exemplary embodiment;

FIG. 4 illustrates a representation of a period selection display in accordance with an exemplary embodiment;

FIG. 5 illustrates a representation of a display in accordance with an exemplary embodiment;

FIG. 6 illustrates a representation of a display in accordance with an exemplary embodiment;

FIG. 7 illustrates a representation of a display in accordance with an exemplary embodiment;

FIG. 8 illustrates a representation of a display in accordance with an exemplary embodiment;

FIG. 9 illustrates a representation of a host selection display in accordance with an exemplary embodiment;

FIG. 10 illustrates a representation of a display in accordance with an exemplary embodiment;

FIG. 11 illustrates a schematic representation of a system in accordance with an exemplary embodiment implemented in a cloud computing environment; and

FIG. 12 illustrates a general computer architecture in accordance with an exemplary embodiment.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching relates to methods, systems, and programming for detecting, analyzing and troubleshooting gaps in system statistics data.

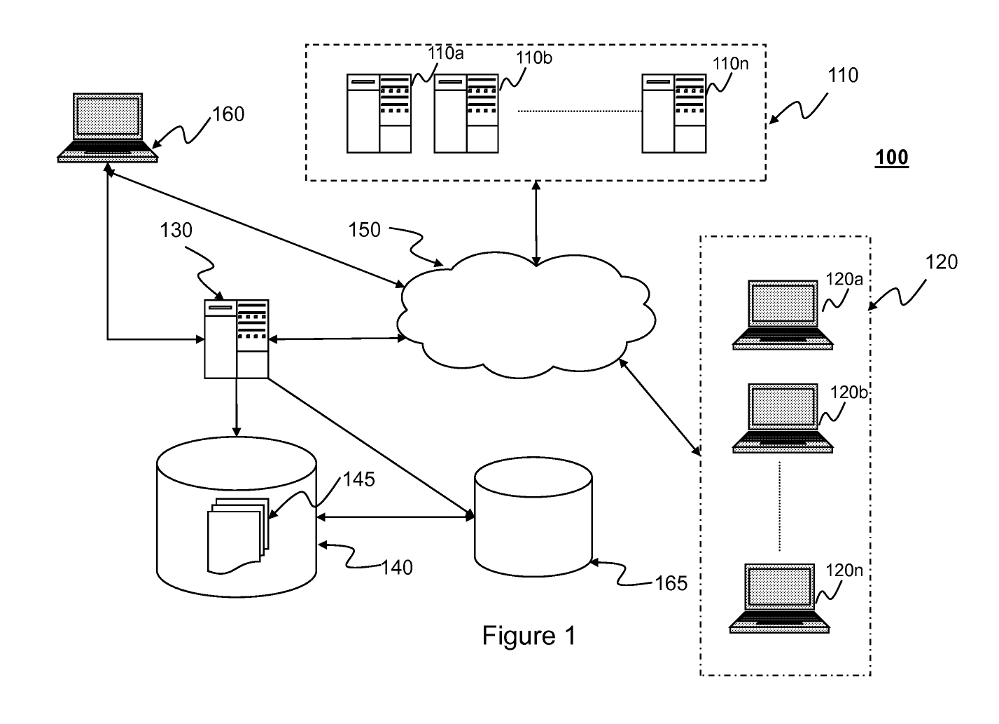

FIG. 1, illustrates a system 100 in accordance with an embodiment of the present disclosure. System 100 may comprise computers, servers, or processors 110, user input terminals or computers 120, workload center system 130, database 140, log files 145, network 150, user terminal 160, and data archive 165.

Servers 110 may be a single server or processor or may be made up of several servers, processors or hosts 110a, 110b, . . . 110n. Each server or processor 110a to 110n may be running a separate process or the same process, may be running on a separate server or the same server. User terminals 120a to 120n may be computers running their own processes or may be terminals connected to network 150 and accessing a remote host such as servers 110a to 110n. Both servers 110 and terminals 120 may be wired or wirelessly connected directly to network 150 or may wired or wirelessly connected directly to management server 130.

Network 150 in system 100 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points through which an input source may connect to the network in order to transmit information via the network.

Workload center system 130 may be a workload management system used to gather statistics about the operations, errors, and performance of system 100. It may be implemented on a standalone machine as depicted in FIG. 1 or may be implemented on a server such as 110a. Database 140 may be any type of database or file storage structure, such as an SQL database, and SQLlite database, a relational database, or a flat file. Database 140 may house statistical data files about the operation, usage, and performance of any of the servers 110 or any of the processes they are running. Alternatively, and/or additionally, in an embodiment, the statistical data files may include information about access through user input terminals or computers 120. As data is collected and reported, files 145 within database 140 may omit certain data, may corrupt certain data or there may be no data to capture. Data files 145 may be one large monolithic files or may be a series of smaller files. Additionally or alternatively, data may be stored in data archive 165. The data may either be written directly from workload center 130 to archive 165 or may be moved periodically from database 140 to archive 165.

In an embodiment, a user accesses the data in files 145 by accessing work load center 130 utilizing for example, user terminal 160. The user, via terminal 160 may request a report from work load center 130, such as CPU usage for server 110b within the month of May. Other reports may include work group access data, usage data, performance data, and usage history data. In an embodiment, in response to the user's request, system 130 displays via user terminal 160, a visual report of the status of the data requested. That is, the system 130 may generate a report on the status of the requested records to be displayed to the user at terminal 160. The purpose of the report is to warn the user of any missing, or corrupted records that could affect the validity of the report request. Without such a report, a user would have no information regarding the integrity of the records within the requested period.

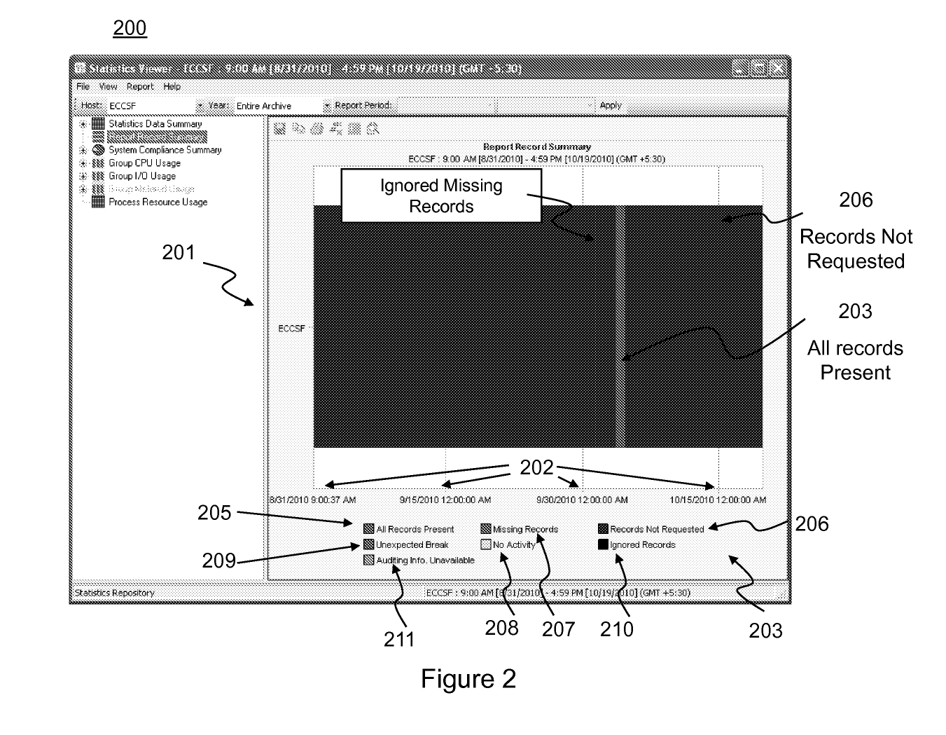

In an embodiment a report record summary 200 as seen in FIG. 2 may be displayed in response to the user's request. The purpose of this report is to warn the user of any missing records that could affect the validity of the current report request. The purpose of the interface is to display the report which gives warning to the user of any missing records that could affect the validity of the current report request. In an embodiment, the gaps or inconsistencies in statistics data for a specific report period will be represented by different bars in a chart and maybe color coded to represent the different status. Each time a user requests a new report, a new report record summary is created for a specific host or server and for a specific time period of the report.

Report 200 shows data area 201 which indicates a large period of data, and may include all the data recorded from the requested application or server. Report 200 includes time markers 202, which may include the start of the report request period, the end of the report request period, and intermediate periods. Alternatively, report 200 may display only areas where missing data, corrupt data, or other non standard data was detected. In such an embodiment, time markers 202 may display areas immediately surrounding problem areas rather then the entire period. In another embodiment, report 200 only displays the requested period. Additionally and/or alternatively, report 200 may not represent a continuous time period, but may only display problem segments of the entire period. As depicted in FIG. 2, report 200 also contains key area 203.

Key area 203 may provide indication of the status of the records. In an embodiment, all records present reference 205, in this case green, represented that all records are present. A record is present for the time period when there are no gaps in the data sequence. i.e. (Record 1, Record 2, Record 3, Record 4).

Not requested references 206 and the corresponding color indication, depicts an area of data for which records have not been requested from the servers by any user. A record is said to have never been requested, when the records for that time period have never been requested by a user. An area where a record has never been requested is considered a gap in the data sequence. Such a gap does not conclusively indicate anything about the data, merely that no user has requested records for that period of time until the current user. A gap may or may not be fillable or repairable based on what data is actually available. Missing records reference 207 may be depicted in red for example. A missing record, in an embodiment, indicates that the records within a sequence, for the period requested are missing. This is different than not requested reference 206 where a record was not requested. Missing records reference 207 for the time period have been requested, but no record is present and there is a gap in the sequence. Such an indication may imply an extraction failure. In such a case, a user may want to attempt to re-extract the records. No activity reference 208 represented in grey indicates that there was no activity within the requested period. The records for time period have been requested in the past, but no record is present and there are no gaps in the sequence.

Unexpected break reference 209 depict an unexpected sequence number break. That is, the record sequence numbering is non-sequential. A higher sequence record number record is typically followed by a lower sequence number record and that lower number is not 1. A reset to 1 is expected periodically. For example, record sequence of 1000, 1001, 1002, 0698, 0697, indicates that the data from that period of time is unreliable because of the break in the records sequence. The user may consider re-extracting that period to see if new records clean-up the sequence problem.

Ignore Missing Records reference 210 may be used to indicate that a user has specifically specified to ignore the missing records for a specified set of extraction blocks. Such a command may be useful when the records are no longer available and the user does not wish to be told about this on every future report.

Auditing information is unavailable reference 211, in some situations, the information needed to display the record gap summary itself may be missing. This is possible when the database version is old or the database does not have the expected information to arrive on the gap analysis data for the specified time interval.

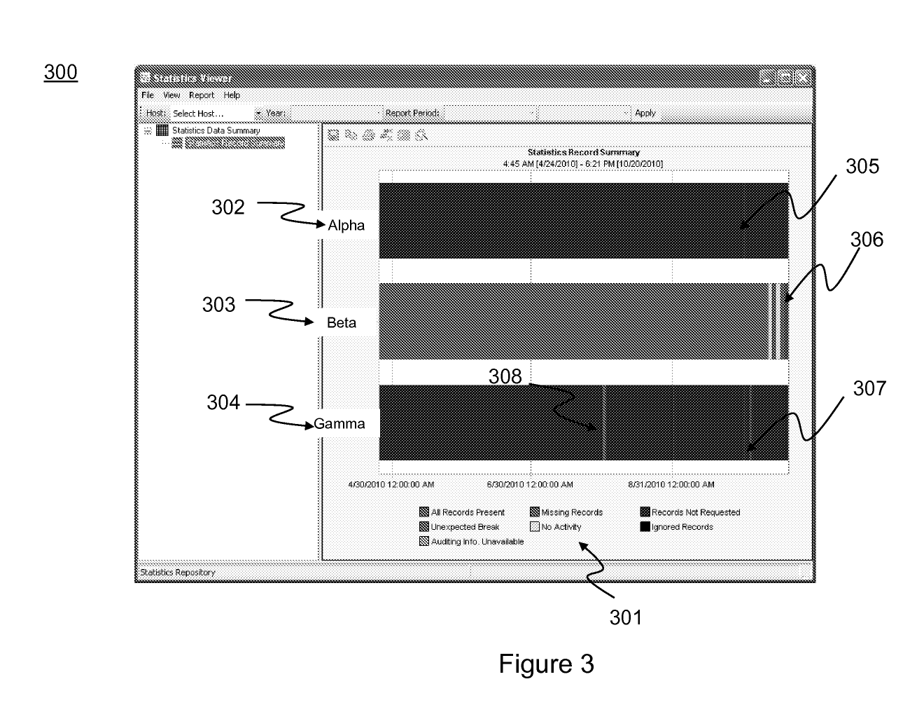

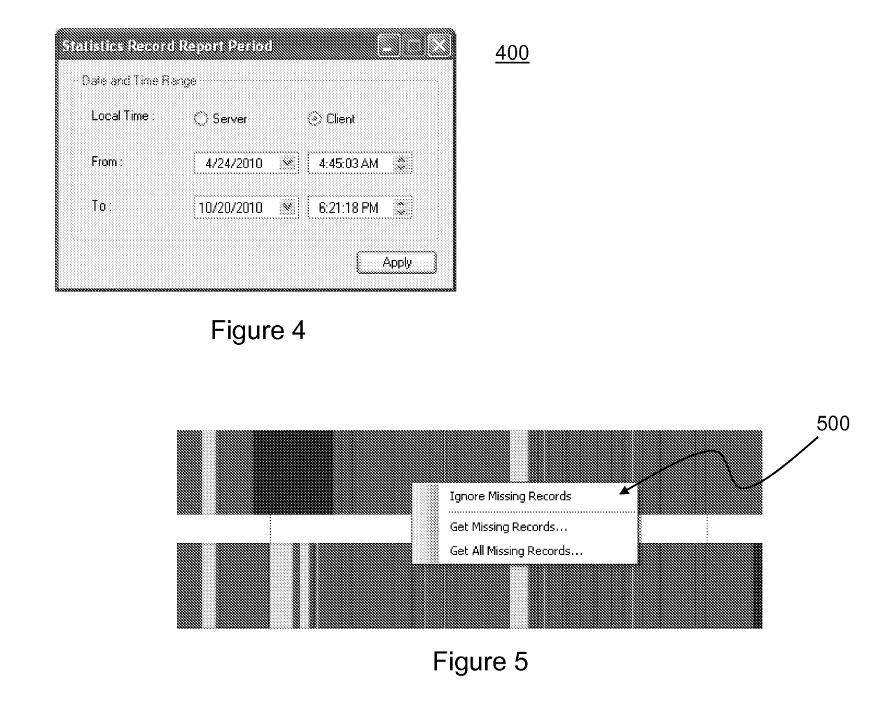

In an embodiment, another report, such as a statistics record summary may be displayed. The statistics record summary allows a user to analyze and validate the database records for a specified period of time. Similar to the report in FIG. 2, the statistics record summary seen in FIG. 3 may display the gaps or inconsistencies in statistics data in the repository 140 or in archive 165. These gaps will be represented by different bars in the report 300 and may be color coded in accordance with the key 301 to represent the different status of the data. Similar color coding as the reports record summary may be used. In an embodiment, time period can be specified for the statistics record summary report 300 using standard report time picker dialogs 400 as depicted in FIG. 4, or through a style bar, or any other means such as direct keyboard entry or scroll wheels.

Report 300 illustrates reports for three hosts or servers 110, alpha, beta and gamma for a specific period of time via display bars 302-304. Display 302 indicates that for the specified period, host alpha's records, with the exception of the missing records 305, have never been requested. For beta server, with the exception for the records 306 later in time, all records are missing and for the gamma server 304, there is an unexpected break 308 in the records and records 307 are meant to be ignored.

Such information, prior to an output report of the actual statistics data will allow the user to better understand the data, to request the correct data, and to anticipate issues with the statistical data. In an embodiment, the user may be presented with a method of manually retrieving, repairing, or correcting the missing data or ignoring the data for the current and future reports. When missing or not unexpected sequence break are identified, the user may be able to request them or indicate in the report to ignore them.

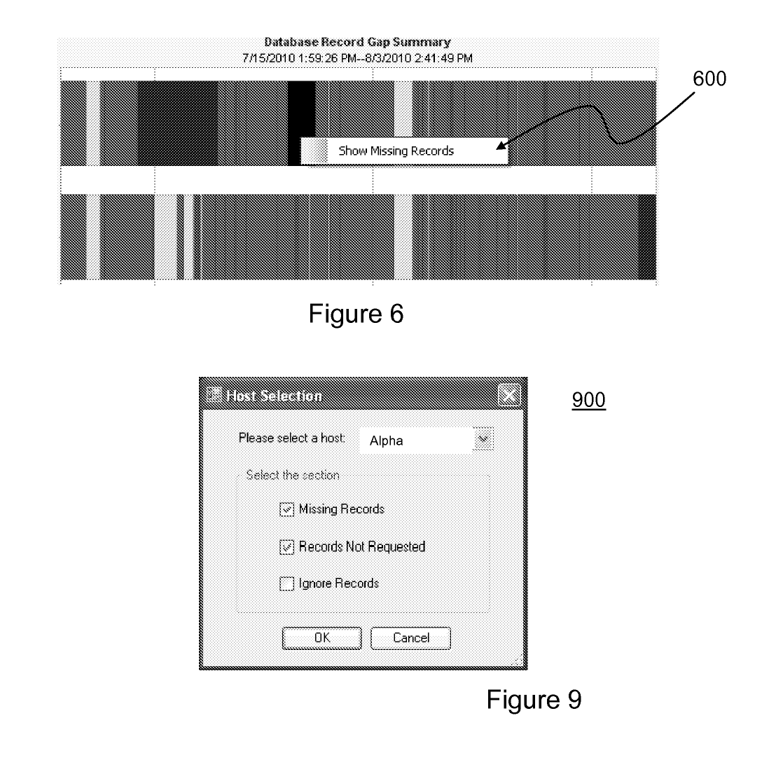

In an embodiment, selection feature are provided to select single or multiple blocks from the chart. Once selected, new context menus as seen in FIGS. 5 and 6, may be provided. A user can select either to extract the data for the selected blocks or to ignore the missing records so that it will not be reported as an inconsistency or gap in the statistics viewer reports during future reporting.

When a record report 200 shows missing records, not requested records or unexpected sequence break, the user may be able to select “Get Missing Records” from the context menu 500 as seen in FIG. 5. The context menu will appear when the user selects the blocks by any known means such as clicking, highlighting, dragging, pointing, or touching. The user will have the option to get the missing records or to ignore missing records for Missing Records 207, Not Requested Records 206 and Unexpected Breaks 209. By clicking on, or selecting the missing record, for example by using a mouse or other pointing device, the system will retrieve the records if they are available and update the report display as appropriate. When the “Get Missing Records” option is selected the data will be extracted from the host for the specific period of time.

Similarly, when a record report 200 shows missing records, not requested records or unexpected sequence break the user should be able to select the block or consecutive blocks area on the display, by using a mouse, touch pad, touch screen, highlight window, or other point device, and is able to select “Ignore Missing Records” from the context menu 500. This instructs the system to ignore the missing records for the specified blocks. These blocks are then excluded from future warnings and reports. If, however, as seen in FIG. 6 the user decides to later include these blocks, the user may highlight a block (or series of blocks) that are coded with Ignore Missing Records 210 and select Show Missing Records from context menu 600, causing the blocks to be reevaluated and included in future reports.

Additionally or alternatively, in an embodiment the requested records are automatically remediated and the missing, or omitted records, previously identified are requested from the respective hosts for the entire specified period of time where the missing records are identified.

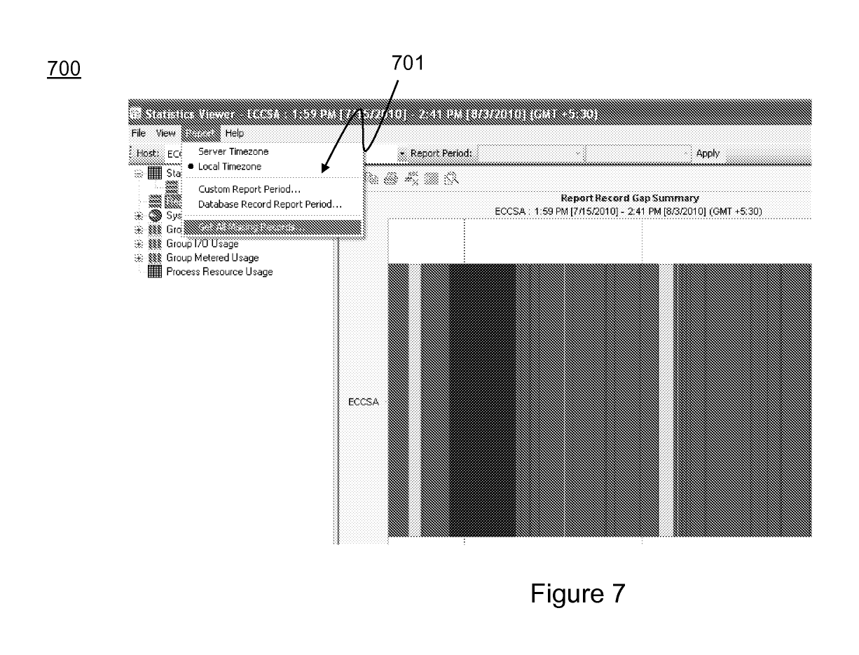

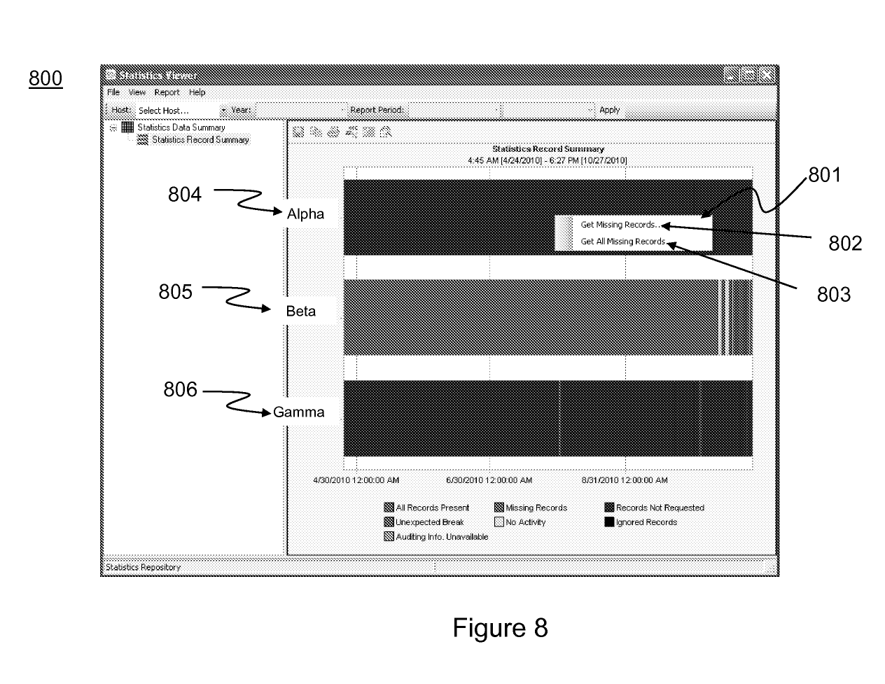

Based on time and record sequence information, system 130 can determine the best way to retrieve the missing records. System 130 may ask the user to enter the credentials via terminal 160 if an automatic connection to systems 110 are not possible. The previously missing or omitted records are extracted from the systems 110 and merged into database 140. In an embodiment, a “Get All Missing Records” drop down menu 701 as seen in FIG. 7 can be added to a report menu 200. Additionally, or alternatively, a separate pop up window could be utilized and invoked by any known means, such as mouse clicking, touch screen, or the use of a hot-key. It is to be understood, that the “Get All Missing Records” function and menu may be incorporated into other reports, such as report 300 as well. As seen in FIG. 8, pop-up menu 801 allows the user to get specific missing records by selecting “Get Missing Records” 802 or “Get all Missing Records” 803. Alternatively or additionally, the “Get All Missing Records” context menu 801 can be displayed when any part of the report is right clicked on, or when a cursor or other selection device is placed over an area of missing records. Furthermore, a radio button or other selection device may be used.

As seen in FIG. 8, in an embodiment, when report 800 displays multiple data sources such as hosts alpha 804, beta 805, and gamma 806, a dialog box or menu 900 as seen in FIG. 9 can be displayed asking the user to specify the host (alpha, beta, or gamma). To aid the user, all the sections will be checked by default except the ignored records section. If the user wishes to include or exclude any other options, the respective boxes may be selected or deselected.

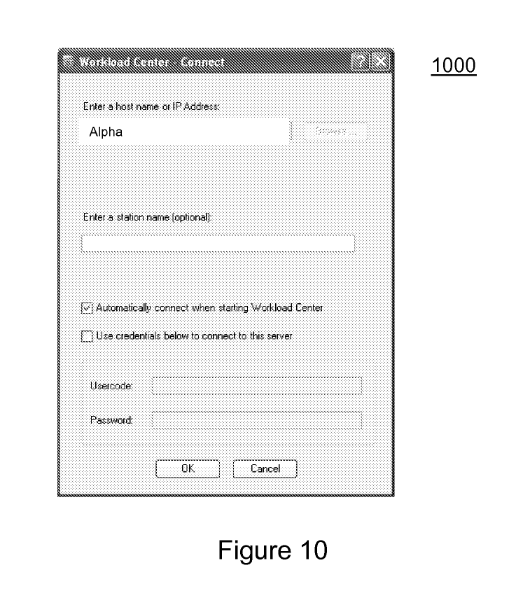

In an embodiment, when a user is interested in a report such as report 200 in FIG. 2, a similar dialog box 900 will open up with the appropriate host 110 being selected and displayed. Alternatively or additionally, in an embodiment, the option to select the time range for extracting the missing records, by default will be populated with the time range for the selected report. If a user wishes to modify the time then a user can change the default from and to time in menu 400. When the request to extract all the missing records is made to a specific host 100 by utilizing selection menu 900, system 130 will try connecting to the respective host 110 automatically. If automatic connection fails, a log message 1000 as seen in FIG. 10 may be displayed.

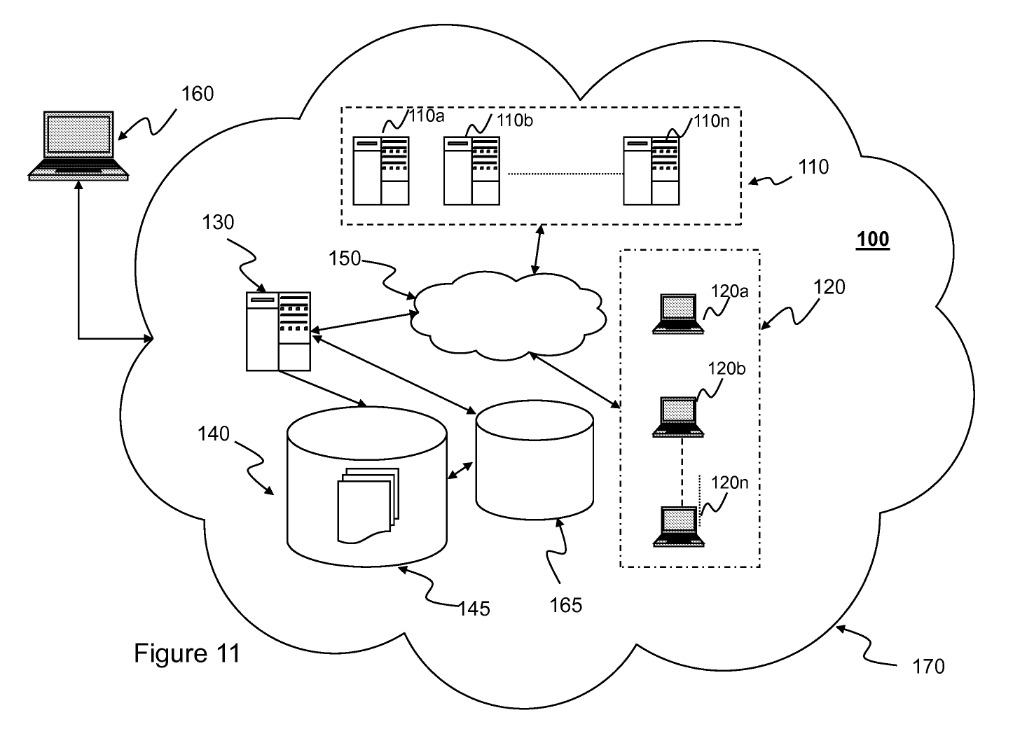

FIG. 11 illustrates an exemplary embodiment, wherein system 100 is implemented in cloud computing environment 170. In this embodiment all or some of system 100 may be implemented in a cloud infrastructure environment. For example, database 140, files 145, and data archive 165 may reside in a cloud environment. Likewise, processors 110, the processors, memory, etc of computers 120, management server 130, and network 150 may all reside in a cloud computing environment, where resources are allocated on an as needed basis.

As used herein, Cloud computing may be a model, system or method for enabling convenient, on-demand network access to a shared pool of configurable computing resources (e.g., networks, servers, storage, applications, and services) that can be rapidly provisioned and released with minimal management effort or service provider interaction. A cloud computing environment provides computation, software, data access, and storage services that do not require end-user knowledge of the physical location and configuration of the system that delivers the services. Cloud computing infrastructure may be delivered through common centers and built-on servers and memory resource.

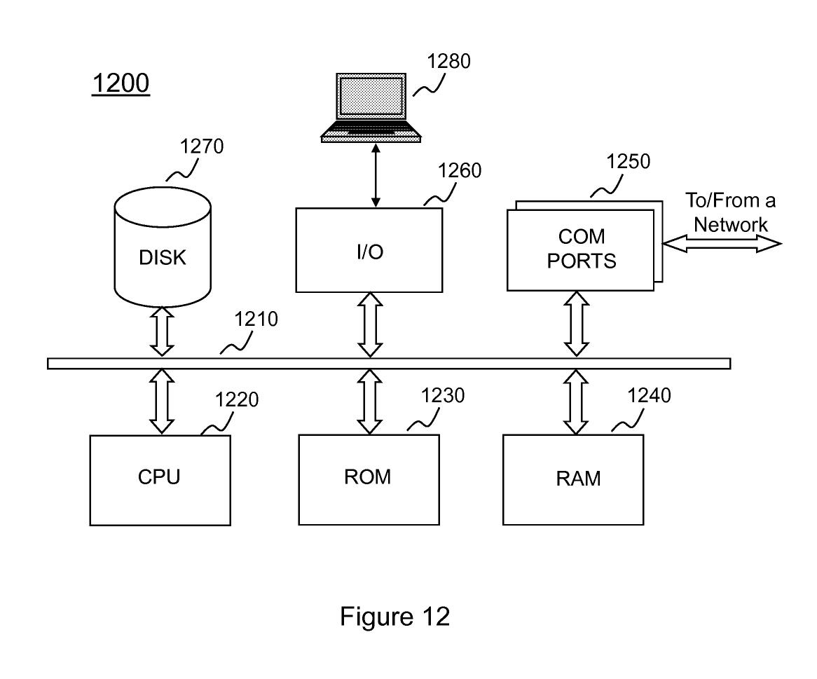

FIG. 12 illustrates a general computer architecture on which the present teaching can be implemented and has a functional block diagram illustration of a computer hardware platform which includes user interface elements. The computer may be a general purpose computer or a special purpose computer. This computer 1200 can be used to implement any component of system 100 as described herein. For example, processors 110, user input terminals, 120, server 130, database 140 files 145 network 150 or user terminal 160 can all be implemented on a computer such as computer 1200, via its hardware, software program, firmware, or a combination thereof. Although only one such computer is shown, for convenience, the computer functions relating to record gap analysis may be implemented in a distributed fashion on a number of similar platforms, to distribute the processing load.

The computer 1200, for example, includes COM ports 1250 connected to and from a network connected thereto to facilitate data communications. The computer 1200 also includes a central processing unit (CPU) 1220, in the form of one or more processors, for executing program instructions. The exemplary computer platform includes an internal communication bus 1210, program storage and data storage of different forms, e.g., disk 1270, read only memory (ROM) 1230, or random access memory (RAM) 1240, for various data files to be processed and/or communicated by the computer, as well as possibly program instructions to be executed by the CPU. The computer 1200 also includes an I/O component 1260, supporting input/output flows between the computer and other components therein such as user interface elements 1280. The computer 1200 may also receive programming and data via network communications.

Hence, aspects of the methods of record gap analysis, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software or systems may at times be communicated through a network such as the Internet or various other telecommunication networks. Such communications, for example, may enable loading of the software from one computer or processor into another, for example, from a management server or host computer into the hardware platform(s) of a computing environment or other system implementing a computing environment or similar functionalities. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method for analyzing data files on a management server having at least one processor, storage, and a communication platform, the method comprising:
retrieving data records from a database to the storage in the management server,
analyzing the retrieved records utilizing the at least one processor;
creating a map of the retrieved records utilizing the management server's at least one processor;
displaying the map of the retrieved records to a user,
wherein the map visually indicates the status of the retrieved data records to be at least one of the following:
all records present, unexpected break in the records, missing records, records not requested, ignored records, no activity, and auditing information unavailable.

2. The method of claim 1 wherein the user selects to ignore the missing records.

3. The method of claim 1 further comprising the steps of
requesting missing data records stored in the database;
retrieving the missing data records from the database;
combining the retrieved records and the missing data records;
recreating the map based on the combining; and
redisplaying the map.

4. The method of claim 1 further comprising the steps of:
requesting previously un-requested records from a server via the communications platform;
receiving the previously un-requested records from the server via the communications platform;
storing the previously un-requested records in the database
combining the retrieved records and the previously un-requested records;
recreating the map based on the combining; and
redisplaying the map.

5. A machine readable non-transitory and tangible medium having information recorded thereon for analyzing data files on a management server having at least one processor, storage, and a communication platform, to causes the machine to perform the following:
retrieving data records from a database to the storage in the management server,
analyzing the retrieved records utilizing the at least one processor;
creating a map of the retrieved records utilizing the management server's at least one processor;
displaying the map of the retrieved records to a user,
wherein the map visually indicates the status of the retrieved data records to be at least one of the following:
all records present, unexpected break in the records, missing records, records not requested, ignored records, no activity and auditing information unavailable.

6. The medium of claim 5 wherein the user can select to ignore the missing records.

7. The medium of claim 5 further comprising the steps of
requesting missing data records stored in the database;
retrieving the missing data records from the database;
combining the retrieved records and the missing data records;
recreating the map based on the combining; and
redisplaying the map.

8. The medium of claim 5 further comprising the steps of:
requesting previously un-requested records from a server via the communications platform;
receiving the previously un-requested records from the server via the communications platform;
storing the previously un-requested records in the database

9. A system for visually displaying the status of data records comprising:
a data management server for requesting data records via a communications link from a plurality of servers;
a memory for storing the data records from the plurality of servers; and
wherein the data management server processes the data records using a processor and generates a visual representation of the status of the requested data records for display on a user terminal.

10. The system of claim 9 wherein the data management server can request missing data records via the communications from the plurality of servers.

11. The system of claim 9 wherein a part of the data management server, the memory, and the plurality of servers may be implemented in a cloud computing environment.
